(19) United States
(12) Patent Application Publication
(10) Pub. No.: US 2012/0098306 A1
(43) Pub. Date: Apr. 26, 2012

(54) Lighted Furniture

(76) Inventors: Michael W. Jarnagin, Moultrie, GA (US); Jonathan Richard Butts, Coolidge, GA (US); Tommy Jack Harper, JR., Coolidge, GA (US)

(21) Appl. No.: 12/911,509

(22) Filed: Oct. 25, 2010

(51) Int. Cl. A47C 31/00; H05B 37/02; F21V 33/00

(52) U.S. Cl. 297/217.6; 362/131; 315/362; 315/291

(57) ABSTRACT

An article of furniture including one or more decorative light members placed along the bottom or other portions of the article furniture is provided. In some embodiments, the article of furniture is a sofa. According to some embodiments, a light member is a light emitting diode (LED) tube. A light assembly including at least one light member that can be removably attached to the article of furniture is also provided. The operation of the light assembly can be controlled by at least one switch used to cut the light member(s) on and off and/or regulate the amount brightness of light emitted from the light member.

### BACKGROUND OF THE INVENTION

1. Field of the Invention

The disclosure relates to furniture, and more particularly, a sofa or other such furniture including one or more light members configured to illuminate an area underneath the furniture.

2. Description of the Related Art

Lighted furniture is disclosed in the prior art. Some of the prior art relating to furniture with lighting features is as follows:

U.S. Patent Application No. 2009/0109661 and U.S. Pat. No. 7,559,667 (Holderman) disclose a lighted cushion for a chair and the like, including a couch, that includes a light string made of LEDs.

U.S. Pat. No. 5,918,932 (Morrison et al.) discloses illuminated furniture, including chairs, wherein the furniture is intended to eliminate the need for other lighting sources.

U.S. Pat. No. 6,595,654 (Washburn) discloses a multifunctional illumination system for furniture, particularly a bed, that includes a light string placed along the edges of the bed. The Washburn disclosure calls for the illumination source to be a halogen source.

U.S. Pat. No. 6,854,869 (Fernandez) discloses an illuminated motor vehicle seat cover. One or more LEDs are coupled to a fiber optic bundle to provide illumination effects to the seat cover.

It is desirable to provide a lighted article of furniture that improves upon the prior art and provides decorative and/or functional illumination and facilitates maintenance, adjustment and replacement of the lighting equipment.

### SUMMARY OF THE INVENTION

The disclosure generally relates to lighted furniture. According to one embodiment, an article of furniture includes a front side, a rear side, a first lateral side extending between front and rear sides, a second lateral side extending between the front and rear sides opposite the first lateral side, and a seating platform supported above a ground surface and configured to support a person's body. The article of furniture further includes a light assembly having a light member positioned below the seating platform, and a power supply configured to provide electric power to the light member. The light member is removably attached to the article of furniture by at least one mounting member, and is configured to illuminate an area between an underside of the seating platform and the ground surface at the front side.

According to another embodiment, a light assembly for an article of furniture includes a light member, a mounting member connected to the light member and configured to releasably attach the light member to a mating surface on the article of furniture, and a power supply configured to provide electric power to the light member.

Additional features and advantages will become apparent to those skilled in the art from the following specification, claims and appended drawings.

### BRIEF DESCRIPTION OF THE DRAWINGS

FIG. 1 is a front view of a sofa including a light assembly configured to illuminate an area underneath the sofa.

FIG. 2 is a rear view of the sofa.

FIG. 3 is a bottom view of the sofa.

FIG. 4 is a perspective view of the sofa.

FIG. 5 shows a light member of the light assembly of FIG. 1.

FIG. 6 shows a detailed view of the light assembly of FIG. 1.

FIGS. 7 and 8 show a power cord connector of the light assembly, wherein the connector is disassembled.

FIG. 9 shows a light assembly according to another embodiment.

### DETAILED DESCRIPTION

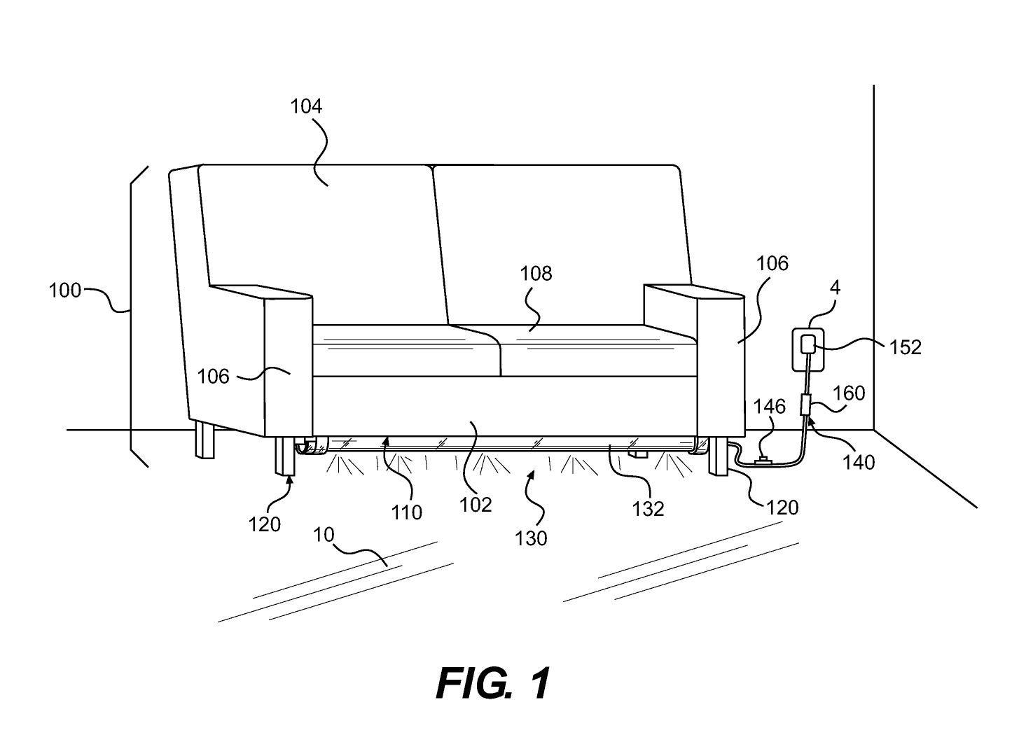

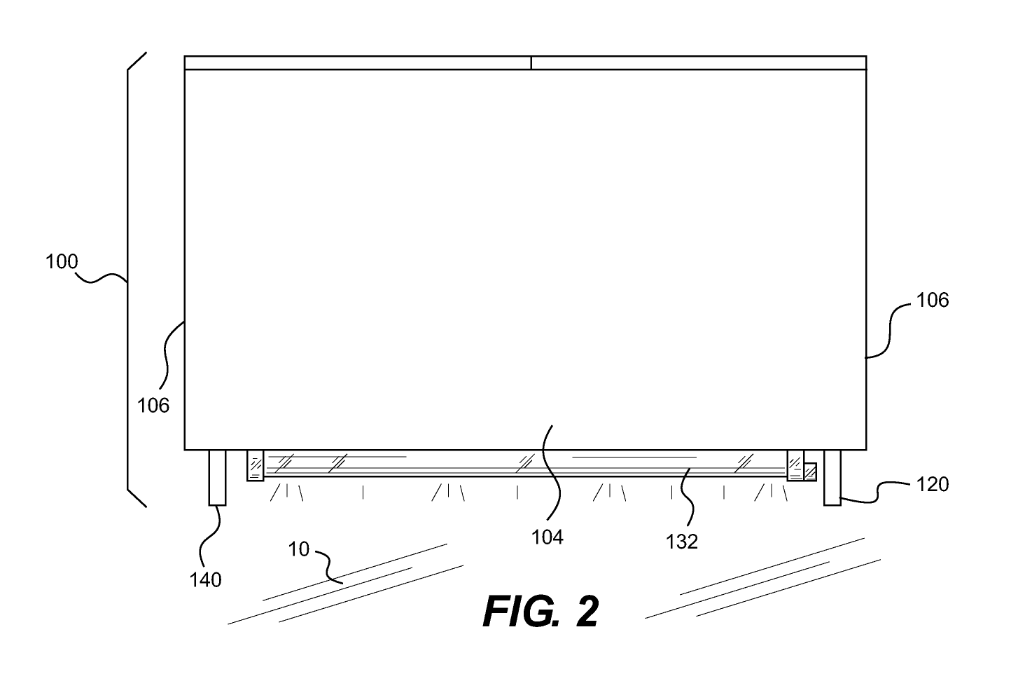

Referring to the appended drawing FIGS. 1-9, in which like numerals refer to like elements throughout the several views, respectively, the disclosure concerns an article of furniture including at least one light assembly configured to illuminate an area underneath the article of furniture. The light assembly includes one or more light members, each of the light members having one or more lighting elements, such as LEDs, that are used to illuminate the area underneath the article of furniture in a functional and/or decorative manner. The disclosure further concerns a light assembly mountable on an article of furniture for functional and/or decorative illumination purposes.

FIGS. 1-4 show a sofa in accordance with an embodiment of the invention. As shown in FIG. 1, the sofa 100 includes a front side 102, a rear side 104, lateral sides 106 positioned opposite one another and extending between the front side 102 and the rear side 104. The sofa 100 also includes a seating platform 108 supported above a ground surface 10 by support members 120. The seating platform 108 is configured to support one or more persons' bodies. Although a sofa 100 is depicted in the drawings, the invention also envisions other articles of furniture such as, but not limited to, chairs, loveseats and chaise lounges.

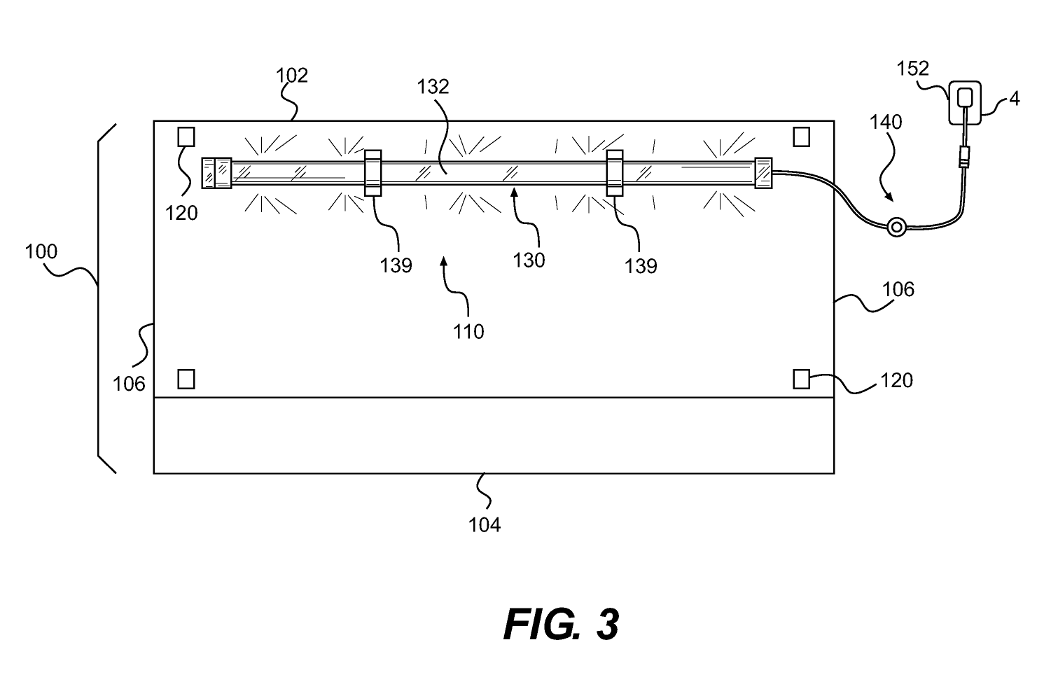

Referring to FIGS. 1-4 and 6, the sofa includes a light assembly 130 having a light member 132 mounted on the sofa 100 at an underside 110 of the sofa 100 below the seating platform 108, and a power supply 140 for supplying electrical power to the light member 132. The light assembly 130 includes mounting members 139 used to secure the light member 132 (FIG. 3) to an underside 110 of the sofa 100. The mounting members 139 can be permanently or releasably attached to the underside 110 of the sofa 100 and releasably secured around the light member 132. In FIGS. 1-4, the light member 132 is turned on and is configured to illuminate the area between the underside 110 of the seating platform 108 and the ground surface 10 at the front side 102 of the sofa 100. As will be described in more detail later, the light assembly 130 is operable such that the light member 132 can be selectively turned on and off by a user.

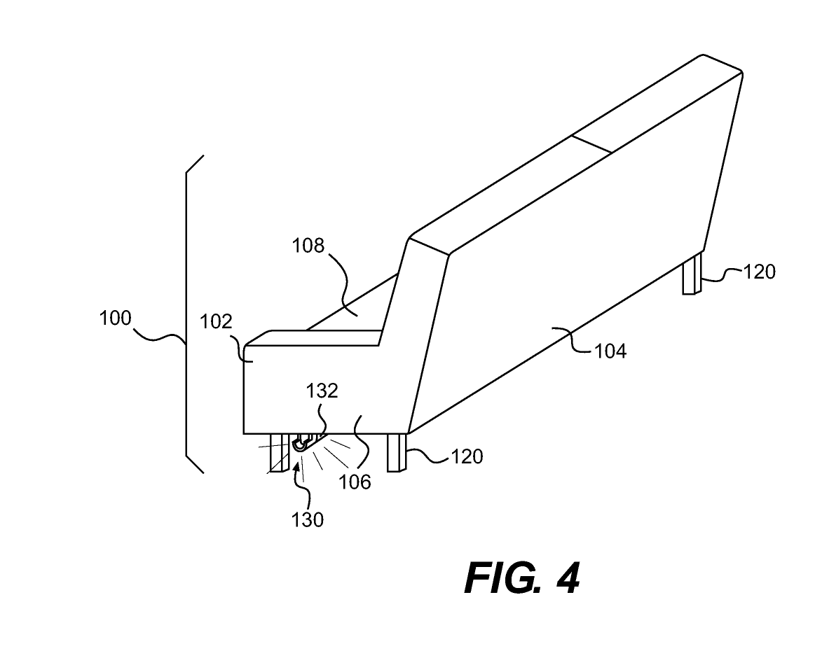

Referring to FIG. 4, the light member 132 is attached to the underside 110 of the sofa 100 between the two support members 120, generally towards the front side 102 of the sofa 100. As shown in FIG. 3, the mounting members 139 can be straps or strips of material having outer surfaces including fabric hooks and loops (i.e., Velcro® material). According to an embodiment, the mounting members 139 can have a first surface comprising hooks and a second, opposite surface including loops. The underside 110 of the sofa 100 can be constructed of a material including fabric loops or hooks configured to interface with the hooks or loops on the first or second surface of the mounting members 139. Each mounting member 139 can be wrapped around the light member 132, and portions of the mounting member 139 can be overlapped such that hooks on the first surface of the mounting member engage loops on the second surface of the mounting member 139, thereby releasably securing the light member 132 within the mounting member 139. Thus, the mounting members 139 and the underside 110 of the sofa 100 can form a hook-and-loop (Velcro®) fastening system for securing the light member 132 to the sofa 100. According to other embodiments (not shown), the mounting members can be stitched onto the underside 110 of the sofa 100 or can include buttons, snap-fit members, screws or any other traditional fastening means configured to interface or interlock with mating members on the underside 110 of the sofa 100. An advantage of the light assembly 130 is that a user can easily remove the light member 132 from the sofa 100 and/or replace the light member 132 when needed by unwrapping the mounting members 139 and releasing the light member 132 from the mounting members 139. Optionally, in embodiments in which the mounting members 139 are releasably secured to the sofa 100, the mounting members 139 can be detached from the sofa 100 in order to facilitate subsequently releasing the light member 132 from the mounting members 139.

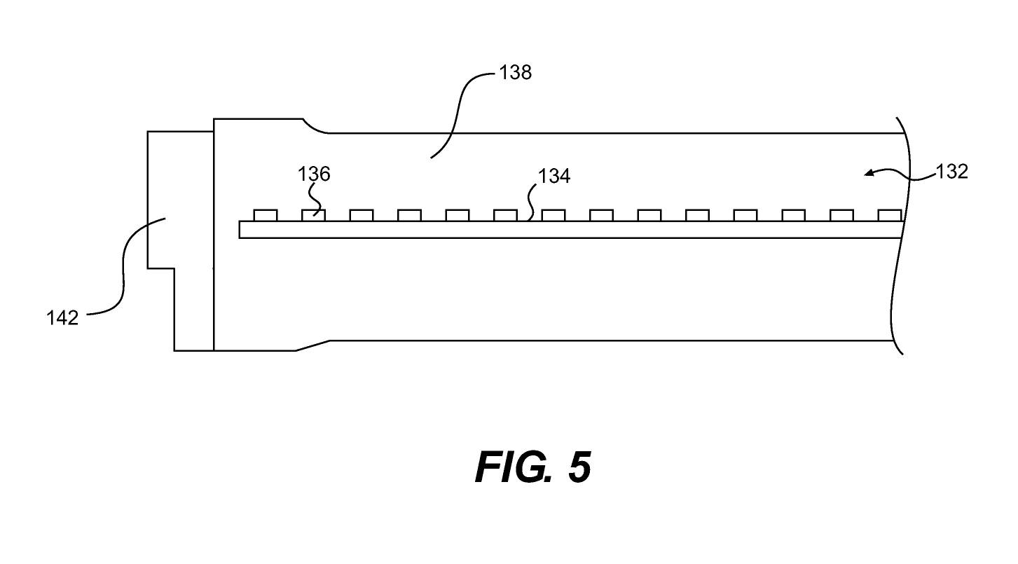

As shown in FIG. 5, the light member 132 can be an LED tube including a printed circuit board 134 having LEDs 136 mounted thereon, and a substantially clear or translucent plastic housing 138 encasing the circuit board 134 and LEDs 136. The interior of the housing 138 can have an etched interior to promote more efficient refraction of light. The housing 138 can be configured to remain cool to the touch when the light member 132 is turned on to illuminate the LEDs 136. According to other embodiments, the housing 138 can be tinted to provide a desired color effect. The LEDs 136 can be configured to emit white light or light of other colors to provide a desired color effect.

According to other embodiments, other types of light members are possible. For example, instead of the LED tube 132 shown and described herein, the light member can include one or more fluorescent lighting elements, one or more incandescent lighting elements, one or more neon lighting elements, or any other type of lighting element(s) capable of providing a desired illumination effect.

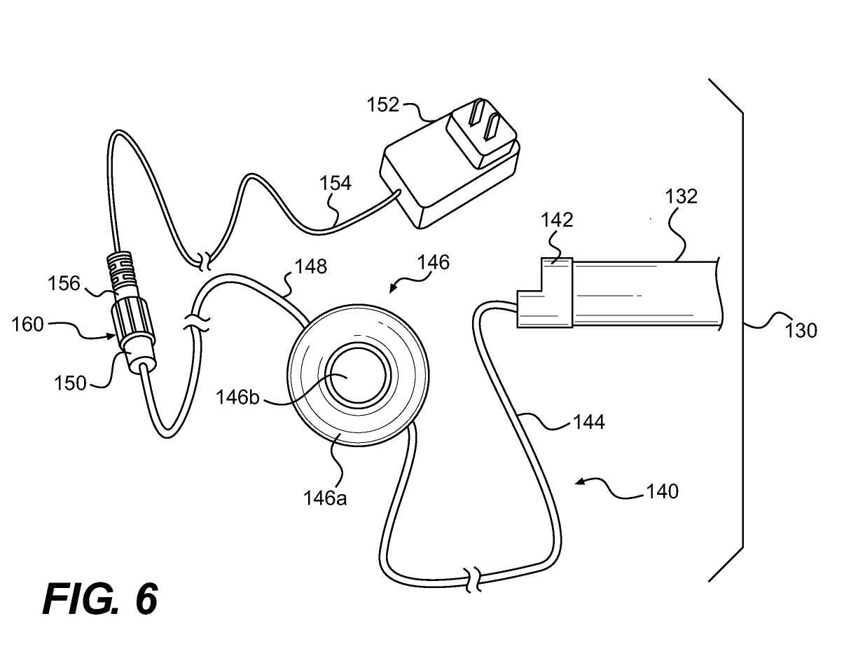

Turning to FIG. 6, the power supply 140 includes an end cap 142 attached to an end of the housing 138, a power cord segment 144 electrically connected to the circuit board 134 and extending through the end cap 142, a power (on/off) switch 146 connected to the power cord segment 144, and a power cord segment 148 connected to the power switch 146 and terminating at a connector member 150. The power supply 140 further includes an AC power adapter 152 configured to be inserted in a power outlet 4 (FIG. 1), and a power cord segment 154 connected to the power adapter 152 and terminating at a second connector member 156. The members 150, 156 attach to each other to form a connector 160 that establishes an electrical connection between the power adapter 152 and the power switch 146.

The end cap 142 can be releasably or permanently secured to an end of the housing. The end cap 142 is configured to cover a portion of the power cord segment 144 and secure the power cord segment 144 in the vicinity of the connection between the power cord segment 144 and the circuit board 134.

The power switch 146 can include a base 146a and an actuator 146b which can be actuated to turn the light member 132 on and off. As shown in FIG. 1, the base 146a can be configured to rest on the ground surface 10, and the actuator 146b can be actuated by a user's foot or hand to move the actuator 146b between positions for turning the light member 132 on and off. According to an embodiment, the switch 146 can be positioned underneath the sofa such that it is generally hidden from plain view. The actuator 146b can be a push button, a sliding member, a rotary knob, a toggle member or a touch-sensitive pad, for example. According other embodiments, the base 146a can be mounted on any surface of the sofa 100, or on a wall, to facilitate operation of the actuator 146b by a user's hand.

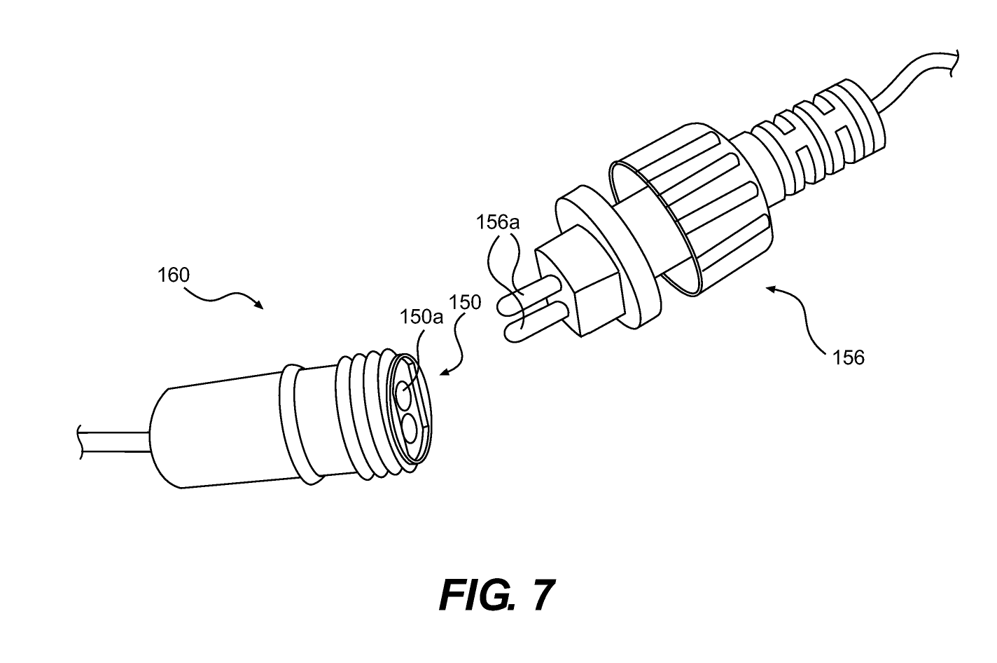

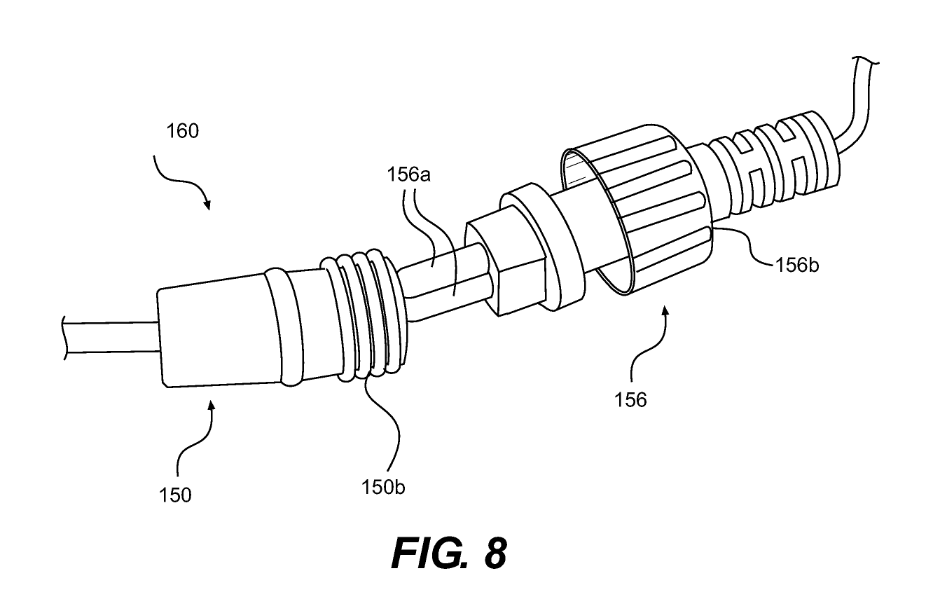

FIGS. 7 and 8 show the connector 160 in greater detail. As shown in FIG. 7, the connector 160 can be a polarized threaded connector. More specifically, the connector member 150 can be a female threaded connector and the connector member 156 can be a male polarized dual-pin connector member. The male connector member 156 can include pins 156a configured to be inserted into sockets 150a located in the female connector member 150 to establish an electrical connection between the members 150, 156. As shown in FIG. 8, the male connector member 156 can have an internally threaded fastening ring 156b and the female connector member 150 can have an externally threaded outer portion 150b that can be screwed onto each other to secure the connector members 150, 156 together once the pins 156a are inserted in the sockets 150a. The polarization of the connector member 156 ensures that voltage polarity does not get reversed when the connector member 156 is electrically connected to the light member 132. Furthermore, the connector 160 enables the light member 132 to be disconnected from AC power by detaching the connector members 150, 156. Thus, the sofa 100 can be moved for cleaning or other purposes, and the light member 132 can safely be replaced without having to unplug the power adapter 150 from the power outlet 4.

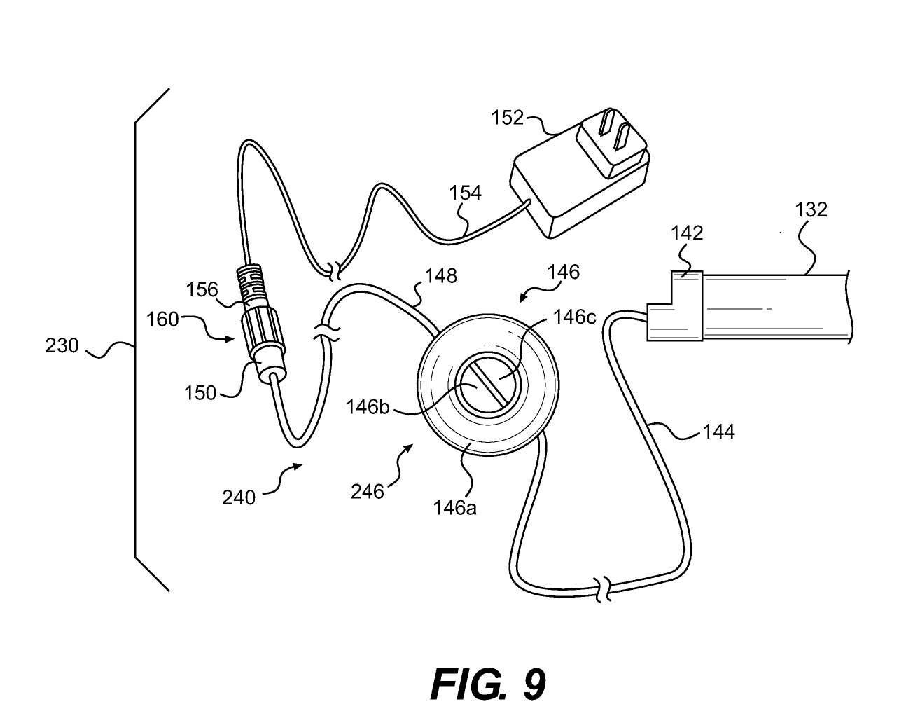

FIG. 9 shows a light assembly 230 according to another embodiment, which can be used in the place of the light assembly 130. The light assembly 230 is similar to the light assembly 130, with the exception that the light assembly 230 includes a power supply 240 having an illumination control switch 246. The illumination control switch 246 is a combination power and dimmer switch including an actuator 146b configured to turn the light member 132 on and off and an actuator 146c configured to control the brightness of the light emitted by the light member 132. The actuator 146c can be a toggle member, a push button, a rotary knob, a sliding member or a touch-sensitive pad, for example. According to an alternate embodiment (not shown), the actuators 146b and 146c can be provided on separate power and dimmer switches, respectively.

It should be understood that, although the embodiments of FIGS. 7-9 have the female connector member 150 attached to the power cord segment 148 and the male connector member 156 attached to the power cord segment 154, it is possible to change the configuration of the power supply 140 such that the female connector member 150 is attached to the power cord segment 154 and the male connector member 156 is attached to the power cord segment 148.

Additionally, other types of power supplies are possible. For example, instead of a power supply 140 or 240, a light assembly can be provided with a simple AC power cord. Alternatively, the power supply could be one or more batteries. Additionally, commonly used power and/or dimmer switches other than those explicitly described above can be employed.

As shown in FIGS. 1-5, the light member 132 is turned on, and thereby illuminates the area between the underside 110 of the seating platform and the ground surface 10, generally at the front side 102 of the sofa. The illumination pattern generated by the light member 132 can be decorative in nature, and can also be functional in nature by lighting a path near the sofa 100. Light of any color or brightness can be generated to create a desired illumination effect by using various types of LEDs 136 or other lighting elements. The illumination pattern can be, for example, an elongated pattern that substantially fills the space extending between the lateral sides 106 of the sofa 100 at the front edge of the sofa, and can optionally extend beyond the area underneath the sofa 100. According to other embodiments, the light member 132 can be positioned and configured such that the illumination pattern illuminates a more localized region between the underside 110 of the sofa 100 and the ground surface 10. According to other embodiments, the light member 132 can be positioned and configured to illuminate substantially the entire area underneath the sofa 100.

In the embodiments described above, only one light assembly 130 is provided. However, in other embodiments, multiple light assemblies 130 can be placed at various locations on the underside 110 of the sofa 100, or a single light assembly can include several light members 132 positioned at various places on the underside 110 of the sofa 100 and wired together in series or parallel, for example. According to some embodiments, additional light members 132 can be placed on the underside 110 of the sofa 100 near the rear side 104 and/or the lateral sides 106 of the sofa 100 to illuminate areas near the rear side 104 and/or lateral sides 106, respectively.

The furniture described herein is advantageous in that the light assembly can be easily maintained, adjusted and/or replaced. If the light member fails, diminishes in performance, or if a different light member providing a different illumination effect is desired, the light element can be quickly replaced in a cost-effective manner without requiring replacement of the entire light assembly or article of furniture.

It should be apparent that the foregoing describes only selected embodiments of the invention, and numerous changes and modifications may be made to the embodiments disclosed herein by one of ordinary skill in the art without departing from the general spirit and scope of the invention as defined by the following claims and equivalents thereof

What is claimed is:

1. An article of furniture comprising:
a front side, a rear side, a first lateral side extending between front and rear sides, and a second lateral side extending between the front and rear sides opposite the first lateral side
a seating platform supported above a ground surface and configured to support a person's body; and
a light assembly comprising
a first light member positioned below the seating platform and removably attached to the article of furniture by at least one first mounting member, the first light member being configured to illuminate an area between an underside of the seating platform and the ground surface at the front side, and
a power supply configured to provide electric power to the first light member.

2. The article of furniture according to claim 1, wherein the article of furniture is a sofa, a loveseat, a chair or a chaise lounge.

3. The article of furniture according to claim 1, comprising at least one switch configured to control illumination of the first light member.

4. The article of furniture according to claim 3, wherein the at least one switch comprises a power switch configured to turn the first light member on and off and/or a dimmer switch configured to control a brightness of light emitted by the first light member.

5. The article of furniture according to claim 3, wherein the at least one switch is configured to be positioned on the ground surface and configured to be operated by a person's foot.

6. The article of furniture according to claim 1, wherein the first light member comprises an LED tube.

7. The article of furniture according to claim 1, wherein the at least one first mounting member is attached to the article of furniture by a hook and loop fastening system.

8. The article of furniture of according to claim 1, comprising a second light member positioned below the seating platform and removably attached to the article of furniture by at least one second mounting member, the second light member being configured to illuminate an area between an underside of the seating platform and the ground surface at the rear side, the first lateral side or the second lateral side.

9. The article of furniture according to claim 1, wherein the first light member is encased in a transparent or translucent housing that is configured to remain cool to the touch when the first light member is turned on.

10. The article of furniture according to claim 1, wherein the power supply comprises:
an AC adapter configured to be connected to a power outlet; and
a polarized threaded connector configured to electrically connect the AC adapter to the first light member, the polarized threaded connector comprising a male polarized dual-pin connector member releasably attachable to a female connector member.

11. A light assembly for an article of furniture, comprising:
a light member;
a mounting member connected to the light member and configured to releasably attach the light member to a mating surface on the article of furniture; and
a power supply configured to provide electric power to the light member.

12. The light assembly according to claim 11, comprising at least one switch configured to control illumination of the light member.

13. The light assembly according to claim 12, wherein the at least one switch comprises a power switch configured to turn the light member on and off and/or a dimmer switch configured to control a brightness of light emitted by the light member.

14. The light assembly according to claim 13, wherein the at least one switch is configured to be positioned on the ground surface and configured to be operated by a person's foot.

15. The light assembly according to claim 11, wherein the light member comprises an LED tube.

16. The light assembly according to claim 11, wherein the at least one mounting member comprises a strap or strip of material including a hook or loop material configured to form part of a hook and loop fastening system for attaching the light member to the article of furniture.

17. The light assembly according to claim 11, wherein the light member is encased in a transparent or translucent housing that is configured to remain cool to the touch when the light member is turned on.

18. The light assembly according to claim 11, wherein the power supply comprises:
an AC adapter configured to be connected to a power outlet; and
a polarized threaded connector configured to electrically connect the AC adapter to the light member, the polarized threaded connector comprising a male polarized dual-pin connector member releasably attachable to a female connector member.
